(19) United States
(12) Patent Application Publication
(10) Pub. No.: US 2005/0249292 A1
(43) Pub. Date: Nov. 10, 2005

(54) System and method for enhancing the performance of variable length coding

(76) Inventor: Ping Zhu, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/065,637

(22) Filed: Feb. 23, 2005

Related U.S. Application Data
(60) Provisional application No. 60/568,892, filed on May 7, 2004.

(51) Int. Cl. H04N 7/12

(52) U.S. Cl. 375/240.23; 375/240.18; 375/240.03

(57) ABSTRACT

Video data compression requires several calculations to be made repeatedly on pixel data from the video. Some of those calculations are used to determine which way to encode portions of the video data, either to provide the best compression results or simply to comply with the MPEG specification. The present invention presents a set of calculations and logic that can be performed in parallel so that the delay is minimized in order to speed up the compression of digital video data. The present invention provides a third escape mode for use when in performing variable length coding.

### CROSS-REFERENCE TO RELATED APPLICATIONS

The present application claims priority under 35 U.S.C. § 119(e) to U.S. provisional patent application entitled “Video Processing System and Method” filed on May 7, 2004, having Ser. No. 60/568,892, which is incorporated by reference in its entirety.

### BACKGROUND OF THE INVENTION

1. Field of the Invention

The field of the invention is digital video data compression, in particular variable length coding. Still more specifically, the present invention relates to systems and methods for quickly determining which type of encoding to use for discrete cosine transformed, quantized pixel data in video blocks.

2. Description of the Related Art

Video data compression requires several calculations to be made repeatedly on pixel data from the video source. Some of those calculations are used to determine which way to encode portions of the video data, either to provide the best compression results or simply to comply with the MPEG specification. Typically those calculations are done in sequence, which in the worst case can cause a delay 5 times longer than the best case. Since the delay can be significant, this causes buffers to be greater to accommodate the worst case and also negatively affects performance.

The MPEGx (1, 2 and 4) standards specify how digital video data should be compressed and stored. Recognizing that there exists temporal and spatial continuity within a video signal, MPEG standards have been designed to represent video data in a way that takes advantage of the continuity in the signal. Prior art compression algorithms are well understood in the art and specified in complete detail in documents available from the International Standards Organization (ISO). The MPEG video and audio compression data format is widely available and can be purchased from the ISO. ISO/IEC 14496-2 from ISO/SC29/WG11 published in Tokyo, Japan in March 1998 will be used as a reference in describing this invention below. The latest version of the “Coding of Moving Pictures and Audio” standards document is always available from the ISO.

While the compression standards are widely published and well known in the industry, there are diverse ways to implement the compression standards. Prior art public domain or free software-based implementations of the compression algorithms are available on the Internet. Software implementations have acceptable performance but usually require longer than real time to convert video data to the MPEG standard format. In other words, using prior art compression methods, it takes longer to compress the video data than it would to view the video on screen.

With the recent release of 8×DVD writers (meaning hardware that can write or burn a DVD 8 times as fast as DVDs are normally played), it would be convenient to have an MPEG compression system which could run 8 times faster than real time so that video data could be written directly to a DVD without intermediate storage like a large data buffer. While hardware implementations of the compression schemes can be faster than their software counterparts, there continues to be a need for better systems and methods for performing MPEG compression.

Particular elements of the compression scheme must be performed repeatedly when compressing video data. Considering that a typical video stream has 15-30 frames per second and video data is often at VGA resolution (640×480 pixels or 307,000 pixels), almost 5 million pixels must be processed and compressed per second.

MPEG processing uses groups or blocks of 8×8 pixels or 64 pixels as a basic processing unit. In order to have the fastest possible hardware for MPEG processing, it is essential to make the total processing time required for one 8×8 pixel unit as short as possible. Techniques or methods that reduce the time required to process the data contained in each 8×8 pixel image can substantially decrease the time required to complete the compression algorithms and convert the data to an MPEG standard format.

What is needed are systems and methods for speeding up the conversion of uncompressed digital video data into a compressed MPEG format in order to operate at speeds mush faster than real time.

### SUMMARY OF THE INVENTION

According to the MPEG video compression standard, pixel data in 8×8 groups are transformed using a Discrete Cosine Transformation (DCT). Each frame of video data includes such pixel data blocks. After quantizing the resulting values, they are compressed using a variable length code specified by the MPEG standard. The dictionary for the variable length coding scheme in the MPEG4 standard is fixed. Data that cannot be encoded using codes from the VLC dictionary is stored using one of three alternative forms.

The variable length codes indicate various states of the values in the quantized 8×8 matrix resulting from the DCT. According to one approach defined in the MPEG standard, the values in the matrix are serialized starting at the value in the upper left corner and moving back and forth in a diagonal eventually ending on the value in the lower right corner. The discrete cosine transformation usually creates a matrix that contains many zeros and contains relatively few non-zero values. Instead of storing the entire 64 values from the sparsely populated matrix, a list of pairs of values are stored. Each pair includes a run value R and a level value L. Valid run values are 0 to 62 and indicate how many zeros appear before the level value. Valid level values in MPEG4 are −2047 to 2047.

The calculations required to determine the format in which to store the compressed data requires several additions steps and three sequential table lookup steps. Depending on the results of the table lookup steps, the time to complete the calculation typically varies between 4 and 20 clock cycles. Since this calculation must be performed repeatedly, reducing the number of clock cycles to perform the calculation will have a significant performance boost.

The present invention overcomes the problems of the prior art with systems and methods that are performed in parallel in hardware so that the worst-case delay is minimized to speed up the compression of digital video data. Specifically, the present invention described herein performs the above-described calculation within a maximum time using special lookup tables and parallel execution of the calculation and logic. The special lookup tables along with the appropriate logic and arithmetic calculations complete the determination of which format to use in 4 clock cycles in all cases. This is particularly advantageous because it allows the buffers to be reduced in size and reduces the time required for compression.

### BRIEF DESCRIPTION OF THE DRAWINGS

The accompanying drawings illustrate embodiments and further features of the invention and, together with the description, serve to explain the principles of the present invention.

FIG. 1 is a block diagram of a video encoder according to one embodiment of the present invention.

FIG. 2 is a table showing the locations of valid combinations of (run, level) pairs encoded in a compressed form using variable length codes from the dictionary and in accordance with the present invention.

FIG. 3 is a chart indicating which method of encoding to use based on different values of L, R, Lmax, and Rmax.

FIG. 4 is a block diagram depicting a system for determining the method of encoding to use for a given (R, L) pair.

FIG. 5A is a table depicting a mapping between L and Rmax that is used in FIG. 4.

FIG. 5B is a table depicting a mapping between R and Lmax that is used in FIG. 4.

FIG. 6 is a flowchart of a preferred embodiment of the method for performing VLC according to the present invention.

FIG. 7 is a block diagram of one embodiment of the variable length coding unit of the present invention.

### DETAILED DESCRIPTION OF THE EMBODIMENTS

The present invention is now described more fully with reference to the accompanying Figures, in which several embodiments of the invention are shown. The present invention may be embodied in many different forms and should not be construed as limited to the embodiments set forth herein. Rather these embodiments are provided so that this disclosure will be complete and will fully convey the invention to those skilled in the art.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention will now be described in the context and with reference to MPEG compression, in particular MPEG 4. Still more particularly, the present invention will be described with reference to blocks of 8×8 pixels. However, those skilled in the art will recognize that the principles of the present invention are applicable to various other compression methods, and blocks of various sizes.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CDROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

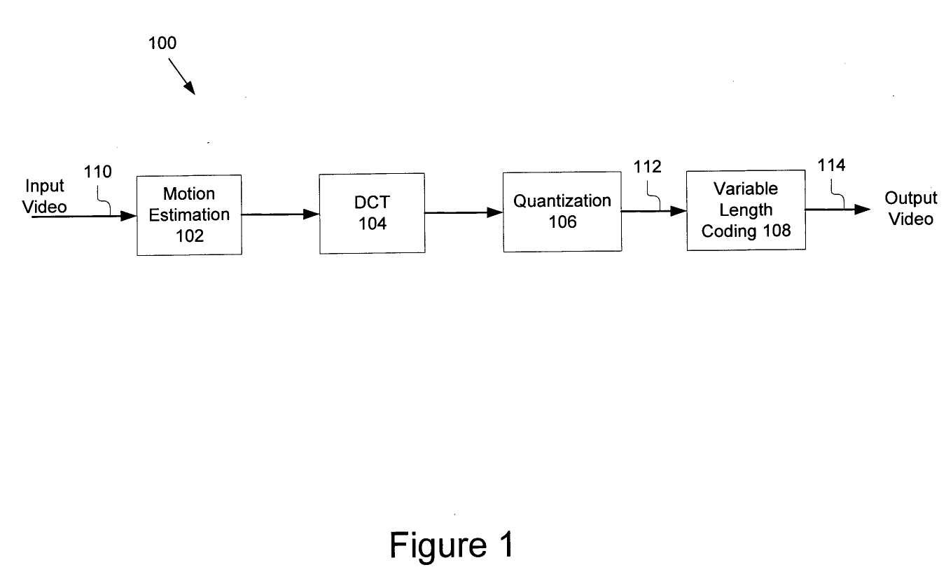

FIG. 1 illustrates a system 100 for coding audio-visual information into a digital compressed format in accordance with the present invention. A raw video signal is input on line 110 to a motion estimation unit 102 that generates the motion vectors that determine how each motion compensated prediction frame is created from the previous frame. Then a discrete cosine transform (DCT) unit 104 converts the signal into elementary frequency components. This separates the image into parts (or spectral sub-bands) of differing importance (with respect to the image's visual quality). Then quantization unit 106 processes the transformed vectors to produce indices representing the original image data on line 112. The quantization unit 106 takes an input vector and outputs the index of the codeword that offers the lowest distortion. In this case, the lowest distortion is found by evaluating the Euclidean distance between the input vector and each codeword in the codebook. Once the closest codeword is found, the index of that codeword is sent through a channel 112. The variable length coding (VLC) unit 108 receives the indices performs variable length coding to further compress the quantized image. The output of the VLC unit 108 is provide on line 114 and provides the compress image data.

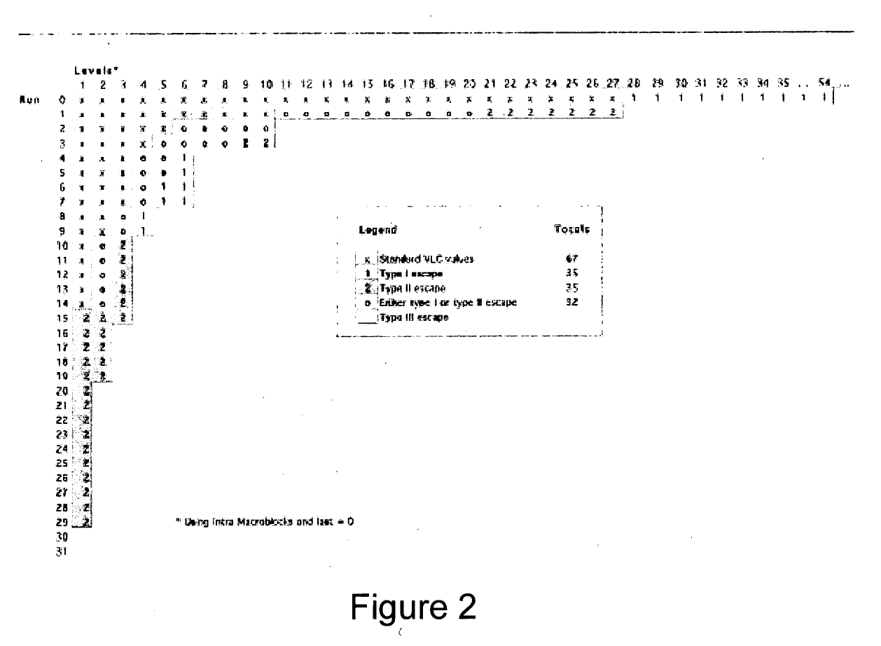

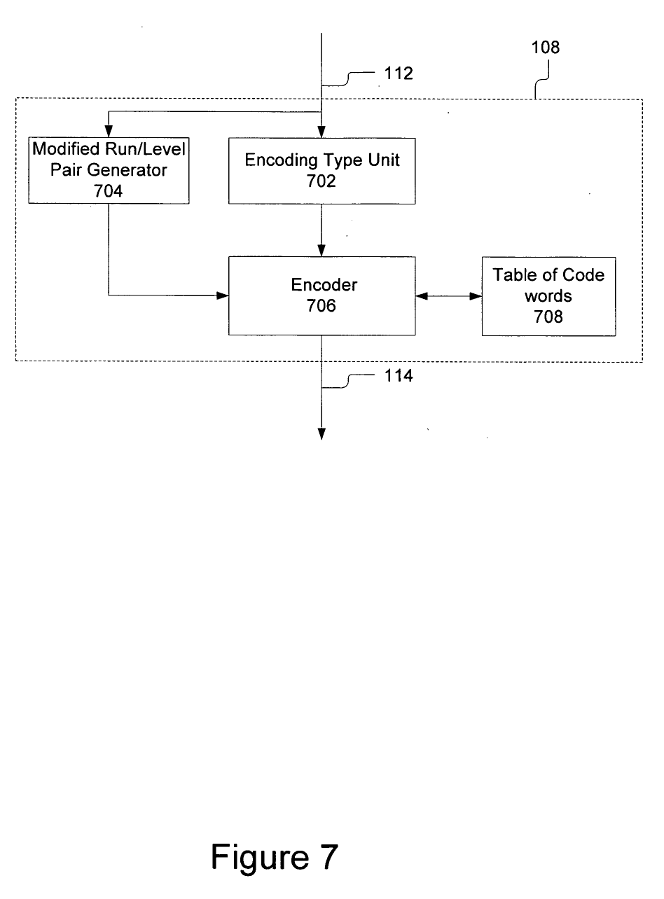

Referring now to FIG. 7, one embodiment of the VLC unit 108 according to the present invention is shown. The VLC unit 108 comprises a encoding type unit 702, a generator 704 for generating modified run-level pairs, and encoder 706, and a table of standard code words 706. The encoding type unit 702 and the generator 704 are coupled to line 112 to receive and process run-level pairs. The encoding type unit 702 is coupled to the encoder 706 and signals the encoder what type of encoding the encoder should perform as will be discussed in detail below. The encoder 706 is coupled to the table 708 and accesses the table to perform standard encoding. The encoder 706 may also encoding using and escape mode I, II or III as will be described above. The generator 704 receives the run-level pairs and produces modified run-level pairs. These modified run-level pairs are provided to the encoder and can be used for encoding instead of the original run-level pairs. The operation of the present invention will be described below in more detail with reference to FIGS. 2-6.

The invention herein described relates to an improved system and method for performing variable length coding. Specifically an improved VLC unit 108 is described in more detail below. While the present invention is described in detail below with reference to encoding according to the ISO MPEG standards, it should be understood that the principles of the present invention are applicable to other encoding methods. The present invention minimizes the time required to determine the type of encoding to use in order to store (run, level) pairs after an 8×8 matrix of video data values is transformed using a discrete cosine transform, quantized and serialized as specified in ISO MPEG standards documents and as described generally above with reference to FIG. 1.

In MPEG4 compression, there are four ways to encode the quantized values. First, for certain (run, level) pairs which occur frequently, an encoding is specified in the MPEG standard which is unique and efficient in that it contains as few bits as possible. This is well known in the art of video data compression and is clearly explained in the ISO MPEG standard so it will not be described here except in an effort to clarify the invention.

Referring now to FIG. 2, there is shown a table indicating which (run, level) pairs can be encoded using one of the four encoding methods specified in the MPEG4 standard. This specific table is used when this (run, level) pair is not the final pair in a block and it is used for “intra” (as opposed to “inter”) Macroblocks. Other tables are used for “inter” macroblocks and for the final pair. Those skilled in the art of MPEG video data compression will be familiar with these terms and with the structure of the table in the figure. Table cells in the figure containing x's indicate (run, level) pairs for which there is a direct VLC encoding. For example, in the quantized video data if there are 3 zeroes followed by a level of 4, there exists a code, specifically 00000010110₂, which represents the pair (3, 4). Hence, the intersection of row 3 and column 4 contains an “X”. There is a column of “X”s in the level 1 column starting at row 0 down to row 14. This indicates that if a level 1 is found and preceded by 0, 1, or up to 14 zeros, there is a variable length code that can be used to represent that run-level (R, L) pair.

The reason that the cells containing “X”s were chosen to have specific variable length codes by the MPEG standards committee is because those pairs are found most frequently in transformed video data and by using the least number of bits to encode those pairs, the video data will be highly compressed.

The variable length code table only represents 67 codes. Increasing the number of variable length codes stored in the table would necessarily increase the length of the codes used to compress the data. Instead of modifying the table to include less frequently used run-level pairs, the MPEG committee chose to implement 3 different escape modes. The MPEG specification details how the escape modes work and what follows is only a brief description. All details can be found in the pertinent ISO standards document.

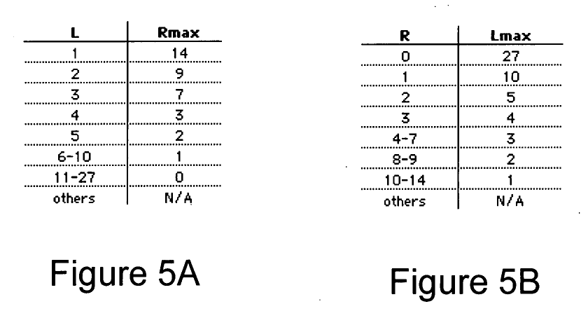

In the following description of the present invention, Rmax refers to the maximum run of zeros represented as a VLC in the table shown in FIG. 2 for a given level L. For instance, if the level L is 1, the maximum number of zeros that can be represented in the table is 14 so Rmax is 14. If the level is 2, Rmax is 9. The relationship between a level L and Rmax is shown in the table in FIG. 5A or graphically in FIG. 2.

Alternatively, for every run of zeros, R, there exists a level, Lmax, that is the maximum level for a given run R that is represented as a VLC. The relationship between R and Lmax is shown in the table of FIG. 5B or graphically in FIG. 2.

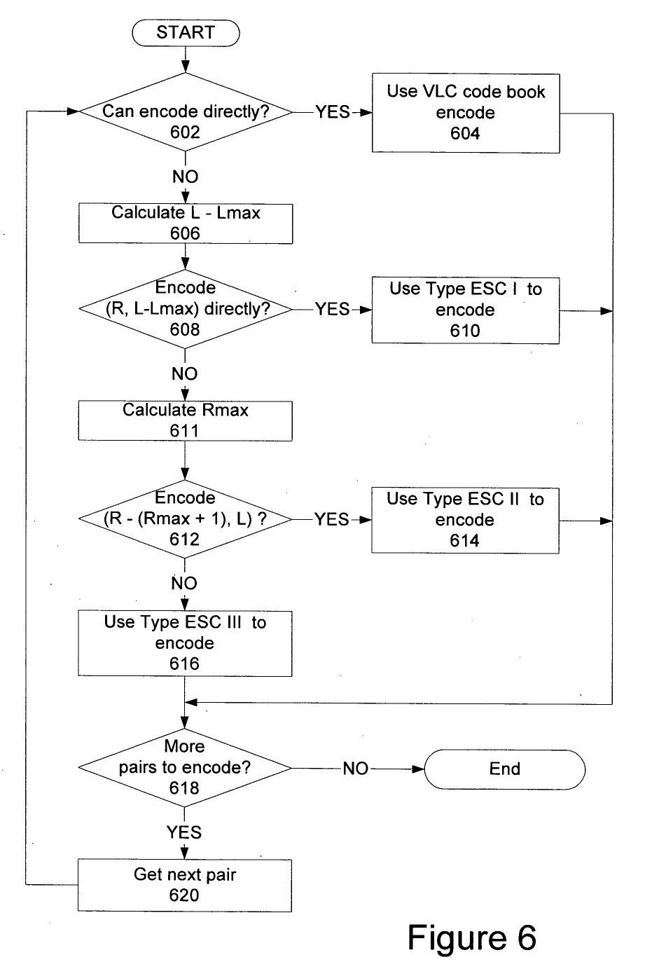

In accordance with the present invention and now also referring to FIG. 6, the following steps are taken to determine how a given run-level pair (R, L) should be encoded in the compressed video data stream. While the description below shows and describes the steps of the process as proceeding in a serial manner, it should be understood that a key aspect of the present invention is that these steps may be performed in parallel. For example, in one clock cycle, the method analyzes which type of escape or normal code, and then the method can perform the VLC table look ups in the following few clock cycles. After these steps one modes must be selected, but the process can be done in a minimum number of clock cycles, significantly fewer that in the prior art or with software operating on a general purpose computer.

The method first determines 602 whether the run-level pair can be directly encoded using the VLC codebook. If the run-level pair (R, L) can be encoded directly using a standard VLC value, the VLC is stored 604 in the compressed video stream and the next run-level pair (R, L) is checked. Specifically, the method determine if there are additional run-level pairs to encode in step 618, and if so gets 620 the next run-level pair and returns to step 602, if there are no more run-level pair, the method is complete and ends.

If the run-level pair (R, L) can't be encoded directly, then L−Lmax is calculated 606 where Lmax is a function of R (Lmax=f(R)). Then the method determines 608 if the pair (R, L−Lmax) can be encoded directly. If the pair (R, L−Lmax) can be encoded directly using a VLC value, then the first type of escape mode (type I) is used 610 for encoding. In other words, the VLC for (R, L−Lmax) is used but it is surrounded by an escape sequence which indicates that the level L retrieved from the table must be added to Lmax to get the true level L.

If neither (R, L) nor (R, L−Lmax) can be encoded directly using a VLC, then another test is done in step 612. Rmax is calculated 611 where Rmax is a function of L (Rmax=f(L)) and if (R−(Rmax+1), L) can be encoded directly 612 using a VLC, then the second type of escape mode (type II) is used 614 for encoding. The VLC which represents (R−(Rmax+1), L) is surrounded by bits indicating the second escape mode is in use and when the run and level are retrieved from the VLC table using the second escape mode, (Rmax+1) is added to the retrieved run value before the (R, L) pair is used for decoding.

Finally, if none of (R, L), (R, L−Lmax), and (R−(Rmax+1), L) can be encoded directly using a VLC, a third escape mode (type III) is used 616 which encodes the run and level directly. In one embodiment, this is done by using the run value plus the level value plus the sign directly. This is the least efficient of the encoding methods and requires the most bits for storage. After the run-level pair is encoded using the third escape mode, the method continues in step 618 to determine whether there are more runlevel pairs to encode.

In order to calculate the compressed video data stream for a transformed, quantized, serialized video data, the above tests 602, 608, 612 must be performed for each (run, level) pair. Every time the third escape mode (type III) is used, the VLC table must be accessed 3 times. Calculating the VLC for a given pair can take many clock cycles in a hardware implementation and looking up a VLC three times to encode a single (run, level) pair is time-consuming and wasteful. Additionally, in some hardware implementations, the design must be based on the worst-case delays. It is wasteful to wait for three VLC lookups for all pairs when most are known after the very first lookup.

Those skilled in the art will recognize that any of the steps for the process outlined in FIG. 6 may be done in parallel in a variety of combinations. For example, steps 602 and 604, steps 606 and 608, steps 611 and 612, and step 616 could all be done in parallel followed by a selection of which type of encoding to use. There are any number of other combinations of steps that can be done in parallel. However, since this operation is performed repeatedly during coding, even reduction of a single clock cycle by the present invention provides a significant performance improvement when doing variable length coding.

Returning now to FIG. 2, table cells containing a “1” indicate (run, level) pairs that can be encoded using the type I escape. Cells containing a “2” indicate pairs that can be encoded using a type II escape. Cells containing a “0” indicate pairs which can be encoded with either a type I or type II escape. Blank cells can only be encoded using the type III escape where the run and level values are encoded directly.

Referring now to FIG. 5A, for each value of L which corresponds to a valid VLC in MPEG4 encoding, there is a maximum number of zeros which can precede it. For instance, if the level value L is 2 the maximum run value R, or in other words, the maximum number of zeros that can precede the level and still be encoded using a valid VLC is 9. In other words, if there are 9 or fewer zeros preceding the level 2, then that (run, level) pair can be encoded without using an escape mode.

Once the level is 28 or higher (or more specifically, the absolute value of L is 28 or higher) there are no values of R for which there is a valid VLC. Hence, in the table of FIG. 5A, there is shown an N/A.

For this invention, a lookup table is implemented in the VLC unit 108 or in memory which returns a value Rmax for a given value of L. N/A is not a valid value to store in a lookup table and for one embodiment of this invention, the value 63 is stored in the Rmax lookup table. In other words, if a level L greater than 27 is provided to the VLC unit 108 and Rmax is requested, the value 63 is returned. This value is invalid because the MPEG4 specification specifically forbids storing a (run, level) pair with R=63 in the video data stream. The invalid value is used in this invention to indicate that there is no VLC available for the given L.

Referring to FIG. 5B, there is no value for Lmax when R is greater than 14. The value 0 is returned when R>14 to indicate an invalid VLC value, 0, is used because it is impossible to store a (run, level) pair where the level value L is 0.

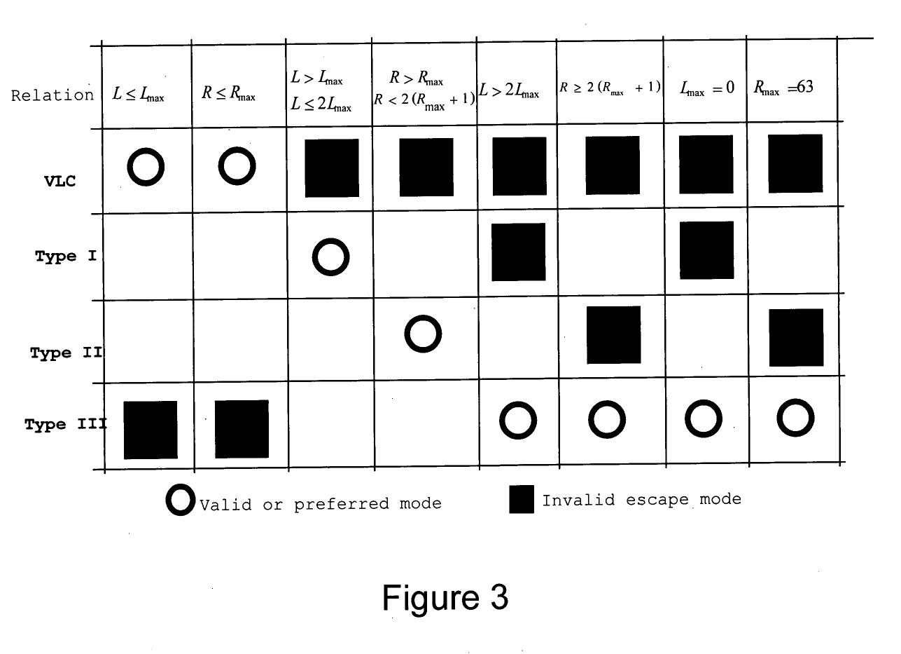

Referring now to FIG. 3, a table is shown which indicates various values which can be looked up or quickly calculated to determine which escape mode can be used. Keep in mind that when a VLC is available, it should be used. FIG. 3 shows a logic table. For a given column, if the equations in the column heading are true, the rows containing squares indicate an encoding type which is not available. In other words, for this table it is possible to use the squares from the columns headed by equations which evaluate to TRUE to eliminate possible encoding modes or types.

Lmax can be calculated (or looked up) based on run R. Rmax can be calculated from level L. Looking at the first column (L<Lmax) and the second column (R<Rmax) it is shown that if either of those two equations are true, VLC encoding can be used. In other words, there exists a valid VLC for both of those two cases. Type III encoding cannot be used in these two cases because the MPEG4 standard specifically forbids encoding (R, L) pairs with the type III encoding when a VLC is available.

As shown in the third column, if L greater than Lmax and L less than or equal to 2*Lmax, escape type I encoding should preferably be used. Escape type III encoding could be used but is unnecessary and is less efficient in terms of bits used. In some cases, escape type II encoding could be used also and in those cases, the best encoding is the one that uses fewer bits in the compressed data stream.

The fourth column indicates where type II encoding is preferably used. If R is greater than Rmax and R less than 2(Rmax+1), type II encoding is the preferable escape mode. However, if (Lmax<L<=2*Lmax), type I encoding is also available and the best encoding depends on the length of the VLC codes used to represent the pairs (R, L−Lmax) and (R−(Rmax+1), L).

As shown in the fifth column, if L>2*Lmax, neither VLC nor type I encoding may be used.

In the sixth column, if R>=2(Rmax+1), neither VLC nor type II encoding is available.

Lmax=0 indicates that it will be impossible to use type I encoding because no valid Lmax is available for the given value of R. VLC encoding is also not possible in this case because there is no VLC code for the given (R, L) pair.

Finally, Rmax=63 indicates that type II encoding is not available because no valid Rmax is available for the given value of L. VLC encoding is also not possible in this case because there is no VLC code for the given (R, L) pair.

In the table shown in FIG. 3, only the cells without squares show possible encoding modes. Which encoding to use is based on determining which columns are true and eliminating those rows containing squares.

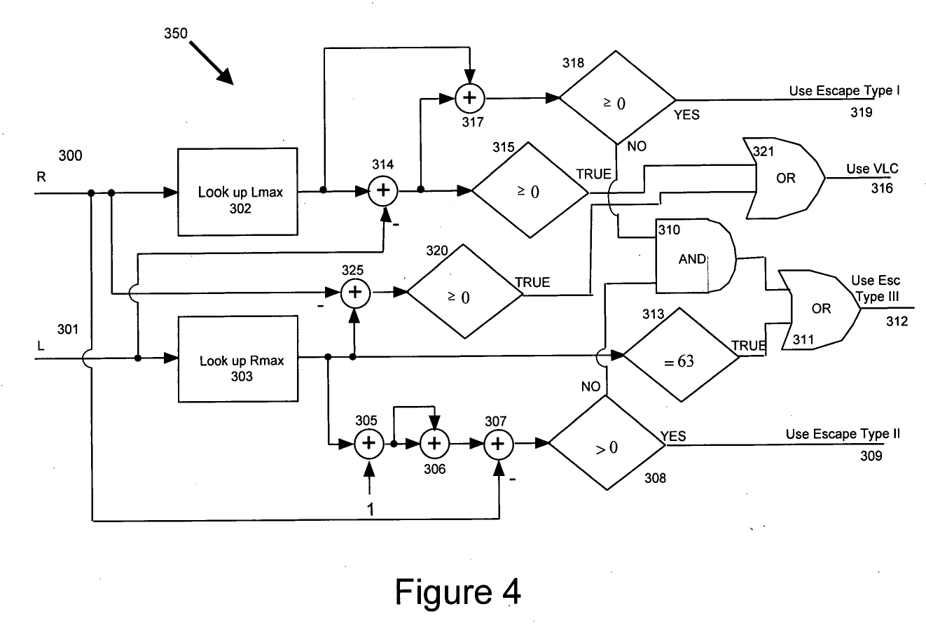

FIG. 4 shows a combination of a calculation flow and logic diagram in which the availability of a given encoding method is determined by calculating in parallel certain values and testing those values to see if they are within certain limits. This arithmetic and logic diagram is another way of diagramming the logic table and equations shown in FIG. 3. Those skilled in the art will recognize various hardware implementations for the VLC unit 108 that may be constructed using the table of FIG. 4.

Referring now to FIG. 4, an exemplary variable length coder 350 is shown. The run R 300 and the level L 301 are the inputs to the coder 350. R 300 is used to calculate or look up Lmax in look-up table 302. The value of Lmax is then used twice and in parallel in one embodiment. Lmax is added to the two summation blocks 314 and 317. The negative of L 301 is added to the summation block 314 to create the value (Lmax−L). At comparator 315, if this value is greater than or equal to zero, a TRUE signal is sent to the OR block 321 and line 316 is TRUE which indicate the coder 350 should use the VLC codebook for coding. Any time that line 316 outputs a TRUE value, the VLC is available for the (R,L) pair and the VLC encoding is used.

At look-up table 303, Rmax is calculated or looked up for a given value of L on line 301. The Rmax value is added to the negated value of R 300 by adder 325 and the result (Rmax−R) is compared with 0 by comparator 320. If the result is greater than or equal to zero, a TRUE signal is sent to the OR block 321 and sign line 316 is asserted TRUE.

At adder 317, the value of (Lmax−L) output by adder 314 is added to the value of Lmax from the look-up table 302. At comparator 318, in parallel to other calculations and logical blocks in one embodiment, if the value from adder 317 (Lmax+Lmax−L) is greater than or equal to zero a TRUE signal is sent on line 319, indicating that it is possible to use escape type I.

At adder 305, the value 1 is added to the value of Rmax output by the look-up table 303. At adder 306, the new value (Rmax+1) is added to itself, doubling it. At adder 307, R 300 is subtracted from the 2(Rmax+1) value. At comparator 308, the output of 307 is compared with zero. If it is greater than zero, a TRUE signal is sent on line 309 indicating that it is possible to use escape type II.

If either comparator 308 and 318 are false, a TRUE signal is sent to the AND block 310. If both 308 and 318 are false, then both send TRUE signals to block 310 and block 310 sends a TRUE signal to the OR block 311. In response, the OR block 311 outputs a TRUE signal on line 312 indicating that escape type III must be used for this pair (R 300, L 301).

From look-up table 303, the value of Rmax is compared with the number 63 at 313. If Rmax=63, a TRUE signal is sent to the OR block 311. In response, the OR block 311 sends a TRUE signal on line 312 indicating that escape type III must be used for this pair (R 300, L 301).

These calculations and logic sequences shown in FIG. 3 can be done either sequentially or in parallel. Executing the sequences in parallel reduces the amount of time required to determine which encoding should or must be used for a given (R 300, L 301) pair, and has significant advantages as has been noted above.

It will be recognized that the descriptions, calculations, and sequences described in this specification represent an embodiment of the invention and that one skilled in the art might implement the same invention in a slightly different manner but one that is in keeping with the spirit of this invention.

### Appendix A

### Exemplary Tables of Values for f(L) and f(R)

TABLE A
ESCL(a), LMAX values of intra macroblocks

| LAST | RUN | LMAX |
|---|---|---|
| 0 | 0 | 27 |
| 0 | 1 | 10 |
| 0 | 2 | 5 |
| 0 | 3 | 4 |
| 0 | 4-7 | 3 |
| 0 | 8-9 | 2 |
| 0 | 10-14 | 1 |
| 0 | others | N/A |
| 1 | 0 | 8 |
| 1 | 1 | 3 |
| 1 | 2-6 | 2 |
| 1 | 7-20 | 1 |
| 1 | others | N/A |

TABLE B
ESCL(b), LMAX values of inter macroblocks

| LAST | RUN | LMAX |
|---|---|---|
| 0 | 0 | 12 |
| 0 | 1 | 6 |
| 0 | 2 | 4 |
| 0 | 3-6 | 3 |
| 0 | 7-10 | 2 |
| 0 | 11-26 | 1 |
| 0 | Others | N/A |
| 1 | 0 | 3 |
| 1 | 1 | 2 |
| 1 | 2-40 | 1 |
| 1 | others | N/A |

TABLE C
ESCR(a), RMAX values of intra macroblocks

| LAST | LEVEL | RMAX |
|---|---|---|
| 0 | 1 | 14 |
| 0 | 2 | 9 |
| 0 | 3 | 7 |
| 1 | 1 | 20 |
| 1 | 2 | 6 |
| 1 | 3 | 1 |
| 0 | 4 | 3 |
| 0 | 5 | 2 |
| 0 | 6-10 | 1 |
| 0 | 11-27 | 0 |
| 0 | Others | N/A |
| 1 | 4-8 | 0 |
| 1 | others | N/A |

TABLE D
ESCR(b), RMAX values of inter macroblocks

| LAST | LEVEL | RMAX |
|---|---|---|
| 0 | 1 | 26 |
| 0 | 2 | 10 |
| 0 | 3 | 6 |
| 0 | 4 | 2 |
| 0 | 5-6 | 1 |
| 0 | 7-12 | 0 |
| 0 | others | N/A |
| 1 | 1 | 40 |
| 1 | 2 | 1 |
| 1 | 3 | 0 |
| 1 | others | N/A |

1. A method for performing variable length coding comprising the steps of:
receiving a run-level pair for input video data;
determining whether the run-level pair can be encoded with a standard code word;
modifying a value of the run-length pair;
determining whether the modified run-length pair can be encoded with a standard code word; and
if the run-level pair cannot be encoded with a standard code word and the modified run-length pair cannot be encoded with a standard code word, directly encoding the run-length pair in an escape mode.

2. The method of claim 1, wherein the step of determining whether the run-level pair can be encoded with a standard code word is performed by determining whether there is a value in a code word table corresponding to the run-level pair.

3. The method of claim 1, wherein the step of modifying the value of the run-level pair further comprises the steps of:
calculating a modified run value; and
using a modified run value and the level value as the modified run-level pair.

4. The method of claim 3, wherein the modified run value is the run value minus the sum of a maximum run value plus one.

5. The method of claim 3, wherein the maximum run value, Rmax, is a function of L (Rmax=f(L)), where L is the level value and f is function provided from a table of values.

6. The method of claim 3, wherein the step of determining whether the modified run-length pair can be encoded with a standard code word is performed by determining whether there is a value in a code word table corresponding to the modified run-level pair.

7. The method of claim 6, further comprising the step of encoding the run-level pair using an escape mode II if the modified run-length pair can be encoded with a standard code word.

8. The method of claim 1, wherein the step of modifying the value of the run-level pair further comprises the steps of:
calculating a modified level value; and
using the run value and the modified level value as the modified run-level pair.

9. The method of claim 7, wherein the modified level value is the level value minus a maximum level value, Lmax.

10. The method of claim 8, wherein the maximum level value, Lmax, is a function of R (Lmax=f(R)), where R is the run value and f is function provided from a table of values.

11. The method of claim 8, wherein the step of determining whether the modified run-length pair can be encoded with a standard code word is performed by determining whether there is a value in a code word table corresponding to the modified run-level pair.

12. The method of claim 11, further comprising the step of encoding the run-level pair using an escape mode I if the modified run-length pair can be encoded with a standard code word.

13. The method of claim 11, wherein the step of determining whether the run-level pair can be encoded with a standard code word is performed concurrently with either the step of modifying a value of the run-length pair, or the step of determining whether the modified run-length pair can be encoded with a standard code word.

14. The method of claim 1, further comprising the step of determining whether there are additional run-length pairs to encode and repeating the steps of receiving, determining, modifying, determining and encoding for at least one additional run-length pairs.

15. A variable length encoder for video data comprising:
a table of standard code words for variable length coding, the table having an input and an output;
an encoding type unit for determining whether a run-level pair can be encoded with using the table, the encoding type unit having an input and an output, the input of the encoding type unit coupled to receive a run value and a level value; and
an encoder for generating variable length codes, the encoder having inputs and an output, the input of the encoder coupled to receive the run and level values, the input of the encoder coupled to the encoding type unit; and
a generator having an input and an output for generating a modified run-level pair, the input of the generator coupled to receive the run value and the level value, the output of the generator coupled to the input of the encoder.

16. The variable length encoder of claim 15, further comprising a generator having an input and an output for generating a modified run-level pair, the input of the generator coupled to receive the run value and the level value, the output of the generator coupled to the input of the encoder.

17. The variable length encoder of claim 15, the encoding type unit signals the encoder whether to encode using a first escape mode, a second mode or a third escape mode.

18. The variable length encoder of claim 15, the encoding type unit signals using the table of code words if there is a code word for the run-level pair received by the encoding type unit.

19. The variable length encoder of claim 15, wherein the encoding type unit signals using the first escape mode if a modified run-level pair can be encoded with a standard code word.

20. The variable length encoder of claim 15, wherein the encoding type unit signals using the second escape mode if a modified run-level pair can be encoded with a standard code word.

21. The variable length encoder of claim 15, wherein the encoding type unit signals using the third escape mode if the run-level pair cannot be encoded with a standard code word and the modified run-length pair cannot be encoded with a standard code word.
